(19) United States
(12) Patent Application Publication
(10) Pub. No.: US 2019/0139184 A1
(43) Pub. Date: May 9, 2019

(54) SCALABLE MEDIA ARCHITECTURE FOR VIDEO PROCESSING OR CODING

(71) Applicant: Intel Corporation, Santa Clara, CA (US)

(72) Inventors: Atthar Mohammed, Folsom, CA (US); Hiu-Fai Chan, Rancho Cordova, CA (US); Hyeong-Seok Ha, Los Gatos, CA (US); Jong Dae Oh, San Jose, CA (US); Karthik Nagasubramanian, Bangalore (IN); Ping Liu, Sunnyvale, CA (US); Samuel Wong, San Jose, CA (US); Satya Yedidi, Roseville, CA (US); Sumit Mohan, San Jose, CA (US); Vidhya Krishnan, Folsom, CA (US); Pavan Kumar Saranu, Bangalore (IN); Ashokanand N, Bangalore (IN)

(21) Appl. No.: 16/235,641

(22) Filed: Dec. 28, 2018

Related U.S. Application Data
(60) Provisional application No. 62/713,202, filed on Aug. 1, 2018.

(51) Int. Cl. G06T 1/20; H04N 19/42; H04N 19/30; G06F 9/38; H04N 19/172

(52) U.S. Cl. CPC G06T 1/20; H04N 19/439; H04N 19/172; G06F 9/3877; G06F 9/382; H04N 19/30

(57) ABSTRACT

Methods, apparatuses and systems may provide for technology that processes portions of video frames in different hardware pipes. More particularly, implementations relate to technology that provides splitting of a frame into columns or rows and processing each of these in different hardware pipes and managing the dependency in hardware. Such operations may achieve this support while at the same time providing enough flexibility to use these pipes independently when the higher performance is not required.

### CROSS-REFERENCE TO RELATED APPLICATION

The present application claims the benefit of priority to U.S. Provisional Application 62/713,202 filed on Aug. 1, 2018.

### TECHNICAL FIELD

Embodiments generally relate to region-based motion estimation. More particularly, embodiments relate to technology that provides scalable video processing and/or coding.

### BACKGROUND

The industry is moving towards higher resolutions and/or higher frame rates. For Virtual Reality usages such a requirement may be for both high resolutions and frame rates, as an example. Codec usages are also moving to higher resolutions and higher bit depths/chroma subsampling ratios. Codec and Processing Pipes often need to be enhanced to support these new requirements.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustrative block diagram of an example decoder implementation of a scalable media architecture system according to an embodiment;

FIG. 2 is an illustrative diagram of an example pipe processing order according to an embodiment;

FIG. 3 is an illustrative block diagram of a partial frames being processed according to an embodiment;

FIG. 4 is an illustrative block diagram of an example frame being split in to columns with an overfetch according to an embodiment;

FIG. 5 is an illustrative block diagram of an example frame being processed so as to share information from the last pixels processed in a first column for processing a second column according to an embodiment;

FIG. 6 is an illustrative block diagram of an example encoder implementation of a scalable media architecture system according to an embodiment;

FIG. 7 is an illustrative block diagram of an example scaling video processing implementation of a scalable media architecture system according to an embodiment;

FIG. 8 is an illustrative block diagram of an example High Efficiency Video Coding video encoder according to an embodiment;

FIG. 9 is an illustrative block diagram of an example video coding system according to an embodiment;

FIG. 10 is an illustrative block diagram of an example of a logic architecture according to an embodiment;

FIG. 11 is an illustrative block diagram of an example system according to an embodiment; and

FIG. 12 is an illustrative diagram of an example of a system having a small form factor according to an embodiment; and

FIG. 13 is a flowchart of an example of a method of scalable media processing according to an embodiment.

### DETAILED DESCRIPTION

As described above, the industry is moving towards higher resolutions and/or higher frame rates. For Virtual Reality usages such a requirement may be for both high resolutions and frame rates, as an example. Codec usages are also moving to higher resolutions and higher bit depths/chroma subsampling ratios. Codec and Processing Pipes often need to be enhanced to support these new requirements.

As will be described in greater detail below, implementations described herein may provide a solution by splitting the frame into columns or rows and processing each of these in different hardware pipes and managing the dependency in hardware. The goal is to achieve this support while at the same time providing enough flexibility to use these pipes independently when the higher performance is not required. This advantageously allows the implementations herein to efficiently use the hardware gates for the maximum feature set. Accordingly, the implementations herein may support higher resolution, higher bit depth, higher chroma subsampling and/or higher frame rate usage across codec and processing engines, while providing flexibility to use the features independently.

Additionally, the codec industry itself typically uses the concept of tiles to achieve parallel processing. However, not all content is tiled when created. Such operations may results in inefficiency of area vs. feature processing from the hardware perspective. Accordingly, such tile-based parallel processing may not scale to various application contexts, such as when content is not tiled when created.

In the implementations described herein, for scaling, there is typically a dependency when the frame is broken and this dependency may be addressed in hardware to get the parallelism as much as possible while still ensuring no artifacts. Further, the implementations described herein may provide the hardware support for content which is not broken into codec tiles and also uses a similar concept for video processing operation enhancement as well. This results in increased area being spent but the area may not be used anytime the new feature set is not enabled. Accordingly, the implementations described herein support both improved performance when required and also allows support for multiple application contexts simultaneously when the higher performance is not required.

As will be described in greater detail below, implementations described herein may split a single frame vertically and handle any dependencies across these vertical columns in hardware. Implementations described herein may introduce the concept of sub frame processing (e.g., via virtual tiles)—where, even if the frame was not encoded as tiles using the standard codec specs, the procedure may break a frame into horizontal/vertical two dimensional arrays and process each of these in parallel for the most part and wait for the dependencies when necessary.

For encoder and decoder implementations described herein, using this concept of sub frame processing allows supporting of higher frame rates/resolutions on frames which were not coded using the standard tiling concept.

For video processing implementations described herein, the same sub frame idea may be extended to video processing operations such as scaling. Scaling typically has to be done on the entire frame as a whole as it will result in artifacts otherwise. The video processing implementations described herein are particularly designed to scale these sub frames while ensuring no artifacts.

Some of the implementations described herein may result in the optimal use of hardware area to achieve the best feature set. For example, the implementations described herein may support higher performance (e.g., higher frame rates, resolutions, and/or bit depth) when required, and at the same time may support simultaneous support of multiple applications when required. From a user point of view, this allows support of the active applications such as virtual reality (VR), which typically require higher frame rates and resolutions. This also allows support of higher resolution/chroma subsampling ratios and bit depths/frame rates for codec operations/scaling operations.

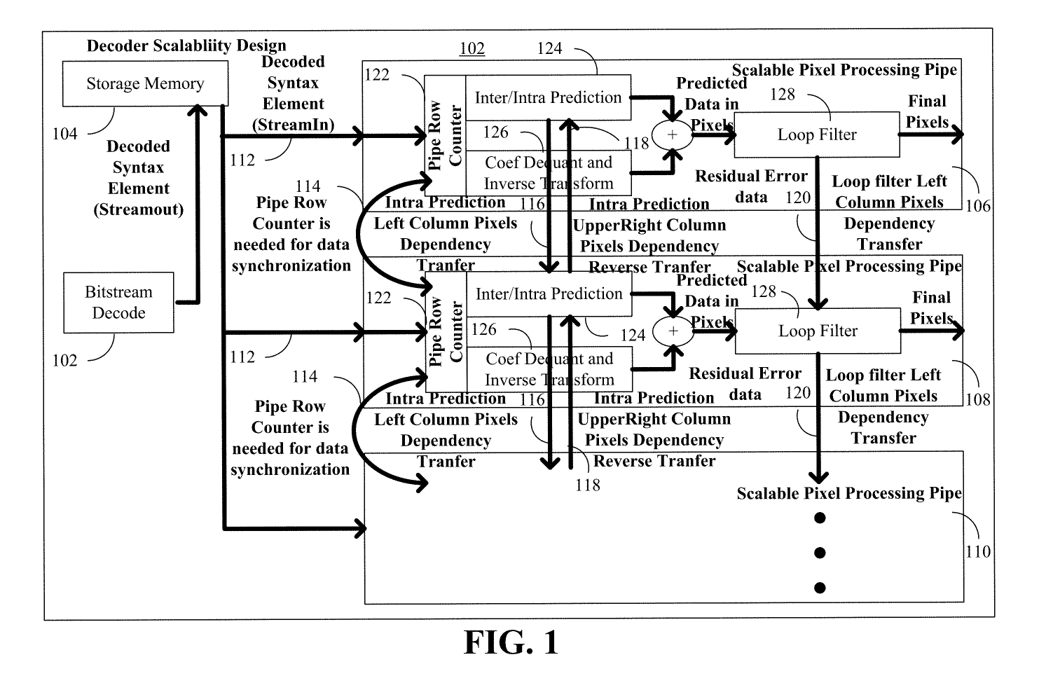

FIG. 1 is an illustrative block diagram of an example decoder implementation of a scalable media architecture system 100 according to an embodiment.

In the illustrated example, scalable media architecture system 100 may be implemented as a decoder scalability design. Since bitstream can be single and sequential for the frame, a single bitstream decode block 102 may be used to decode the bitstream and send the decoded syntax element to storage memory 104.

The scalable pixel process pipes 106, 108, and 110 may process pixels in column and multiple scalable pixel process pipes 106, 108, and 110 can be linked together to process one frame. Each scalable pixel process pipes 106, 108, and 110 may fetch decoded syntax element 112 from system memory 104 for its corresponding pixel columns.

The arrows between scalable pixel process pipes 106, 108, and 110 indicate data dependency transfer between pipes. For example, pipe row counters 114 may be used to track which row in the neighboring scalable pixel process pipes 106, 108, and 110 have been complete. These pipe row counters 114 may be used to synchronize the scalable pixel process pipes 106, 108, and 110 and transfer the dependency data between pipes only when the neighboring pipes have finished the largest coding unit (LCU) with the dependency data.

The remaining arrows indicate the intra prediction left column pixels dependency transfer 116, intra prediction upper right pixel dependency transfer 118, and loop filter left column pixels dependency transfer 120.

In some examples, individual pipes of scalable pixel process pipes 106, 108, and 110 may include a pipe row counter 122 performing the pipe row count for data synchronization. In the illustrated decoder scalability design, individual pipes of scalable pixel process pipes 106, 108, and 110 may perform operations for inter/intra prediction at box 124, coefficient dequantization and inverse transform at box 126, and loop filtering at box 128 to output final pixels 130.

Additionally, scalable pixel process pipe 110 indicates that the backend pixel generation pipes can be scaled up as many times as needed and run in a concurrent manner to process a single picture. Each of the scalable pixel process pipes 106, 108, and 110 may process a column of pixels (e.g., width of the column must be in multiple of sub-blocks (SBs), which can be 16×16, 32×32, 64×64 and specified in the bitstream). Intra prediction and loop filter have data dependency between pixel columns.

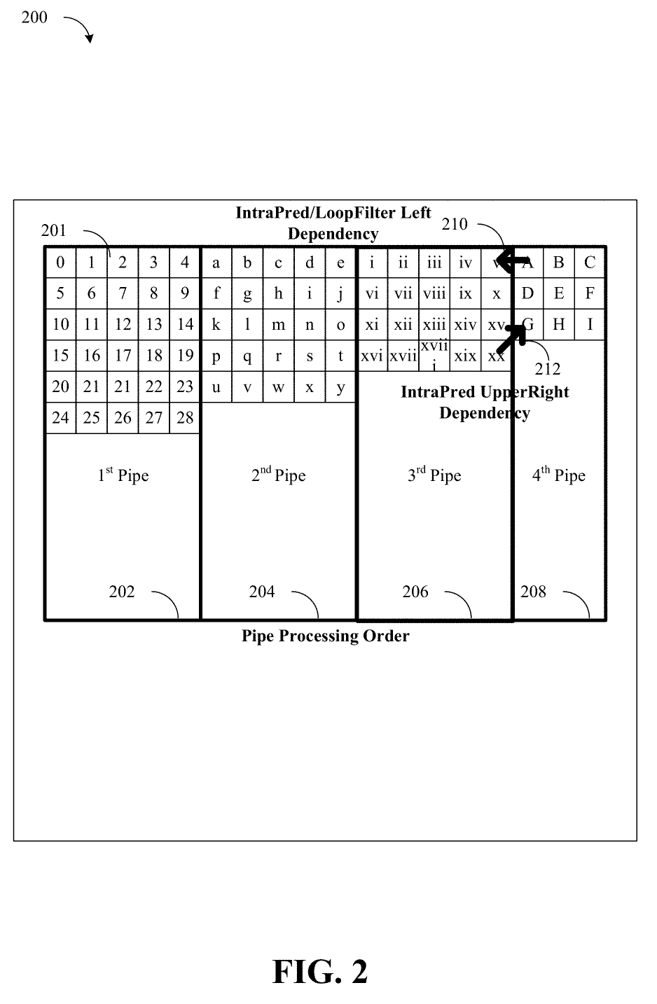

FIG. 2 is an illustrative diagram of an example pipe processing order 200 according to an embodiment.

In the illustrated example, for both encoder and decoder implementations, a picture may be split into columns of pixels in multiple of LCU widths (e.g., an LCU 201 can be 16×16/32×32/64×64 in size). Other than bitstream decode/encode, separate decode/encode pixel processing pipes can process each column concurrently. For example, a first column 202 may be associated with a first pipe, a second column 204 may be associated with a second pipe, a third column 206 may be associated with a third pipe, a fourth column may be associated with a fourth pipe, and so on.

However, there will typically be some data dependency between pipes. Intra prediction and loop filters will likely have left pixel dependency (e.g., to process 4^{th} pipe “A” block, it may require the right column pixels from 3^{rd} pipe “v” block [illustrated here by an arrow 210] prior to starting on the “A” block) and intra prediction also has upper right dependency (e.g., to process 3^{rd} pipe “xx”, it may require the bottom left pixel from 4^{th} pipe “G” [illustrated here by an arrow 212] before working on the “xx” block). To maintain data coherency, each pipe may be required to send a row completion counter to its neighboring left and right pipes, so the neighboring pipes understand which rows its neighbor has finished processing and can request the dependency data properly.

In encoder mode, the dependencies are same as above, however hardware (HW) may insert frame header at the beginning for first tile and tail at the end of last tile in which ever pipe these tiles are being encoded. Also, the tile sizes may be back annotated to the bit stream at the end of encoding each tiles.

Scalability of the Scaling Pipeline

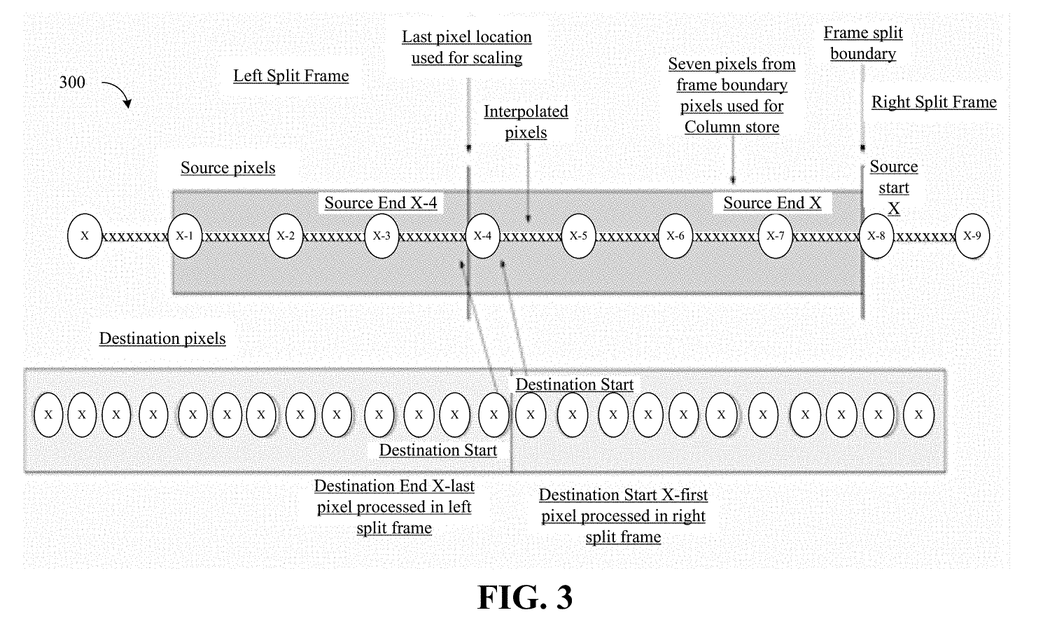

FIG. 3 is an illustrative block diagram of a partial frames 300 being processed according to an embodiment.

The basic principle of the implementations described herein is to achieve scalability in hardware by laying down parallel scaler and format conversion pipes and allowing for independent pieces of the frame to work in parallel. This avoids scaling the entire frame in a single pipe as that will require enhancing the pipe to support higher resolutions.

In some examples, the implementations described herein may use the multiple hardware pipes and use the subframe scaling concept to achieve performance enhancement. The fundamental issue with scaling is the dependency on the adjacent pixels for scaling. One possible scaler is an 8 tap scaler.

As illustrated, FIG. 3 shows the challenges faced when trying to work on partial frames. At the sub frame boundaries, the required information is typically not available to process all the pixels in the sub frame boundary without additional information from the right/left partitions.

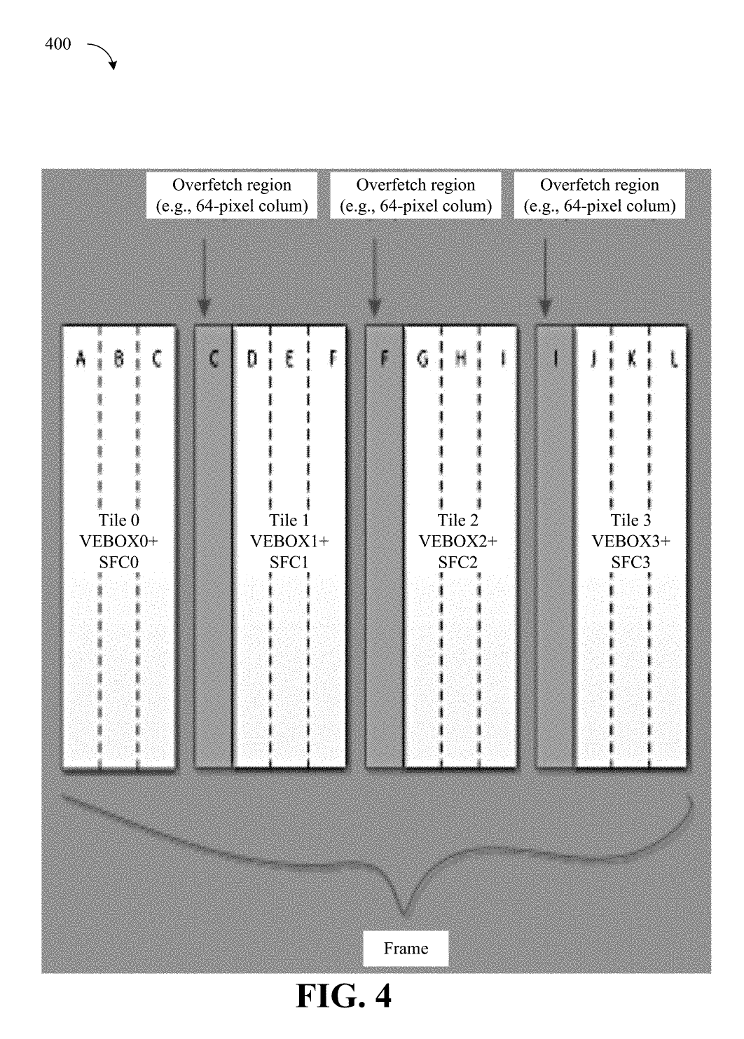

FIG. 4 is an illustrative block diagram of an example split frame 400 being split in to columns 401 with an overfetch according to an embodiment.

In the illustrated example, when connected to the processing engine, the split frame 400 gets processed as columns (e.g., columns of 64 pixels).

In some implementations with a scaler that is an 8 tap scaler, an over fetch 402 may be implemented to occur on the boundaries of the split frame 400. This over fetch 402 is programmable based on the scaling factor but for simplicity of implementation, it may be designed to always over fetch the worst case requirement (e.g., overfetch 64 additional pixels, in this example). The shaded bars in FIG. 4 show the over fetch 402 for the columns 401. Software may program the input and output start, end (x,y) location for each split frame 400 so that scalar-walker may just load these values and start from that point.

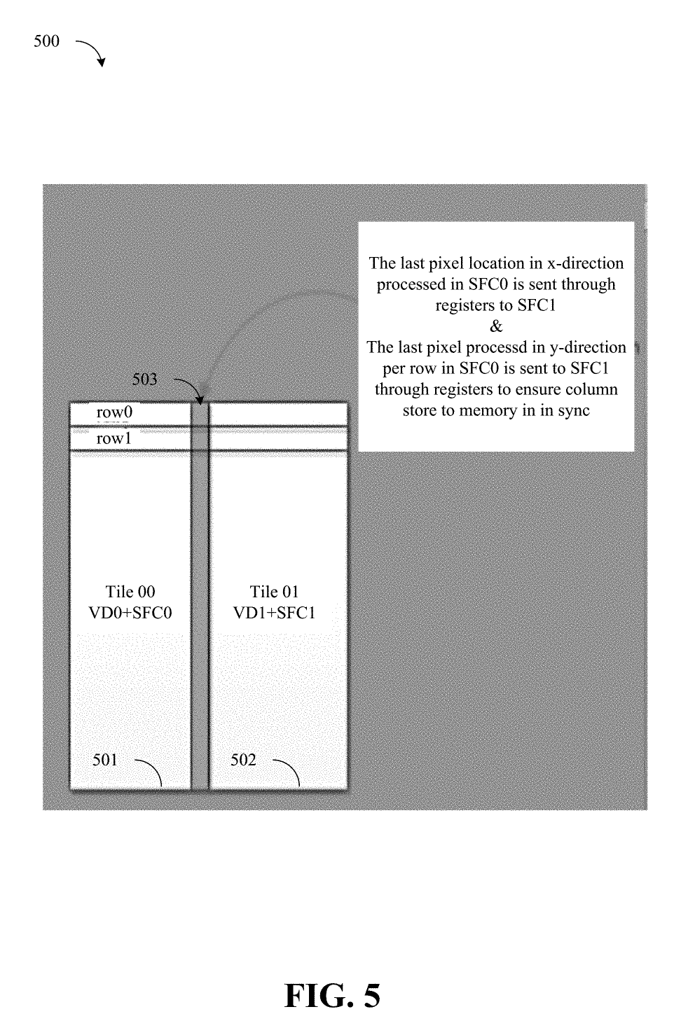

FIG. 5 is an illustrative block diagram of an example frame 500 being processed so as to share information from the last pixels processed in a first column 501 for processing a second column 502 according to an embodiment.

In the illustrated example, similarly, the scaler and format conversion pipe can connect to the codec pipe as well. For this specific case, there may not be any type of over fetch, but there may be hardware blocks to share the information on the last pixel that was processed. This communication between the various scaler pipes may be essential to ensure that the right results are recognized at the edges of the partition. In addition, a first scaler and format conversion pipe (SFC0) for first column 501 may do column-store of pixels to memory (e.g., see the shaded strip in FIG. 5) on every row-tile boundary and issue a communication to a second scaler and format conversion pipe (SFC1) for second column 502 to fetch it from memory for processing remaining row output in next split frame. For example, the last pixel location in the x-direction 503 processed in first scaler and format conversion pipe (SFC0) for first column 501 may be sent through registers for use by second scaler and format conversion pipe (SFC1) for second column 502. Similarly, the last pixel location in the y-direction per row 503 processed in first scaler and format conversion pipe (SFC0) for first column 501 may be sent through registers for use by second scaler and format conversion pipe (SFC1) for second column 502 to ensure that a column store to memory is in sync.

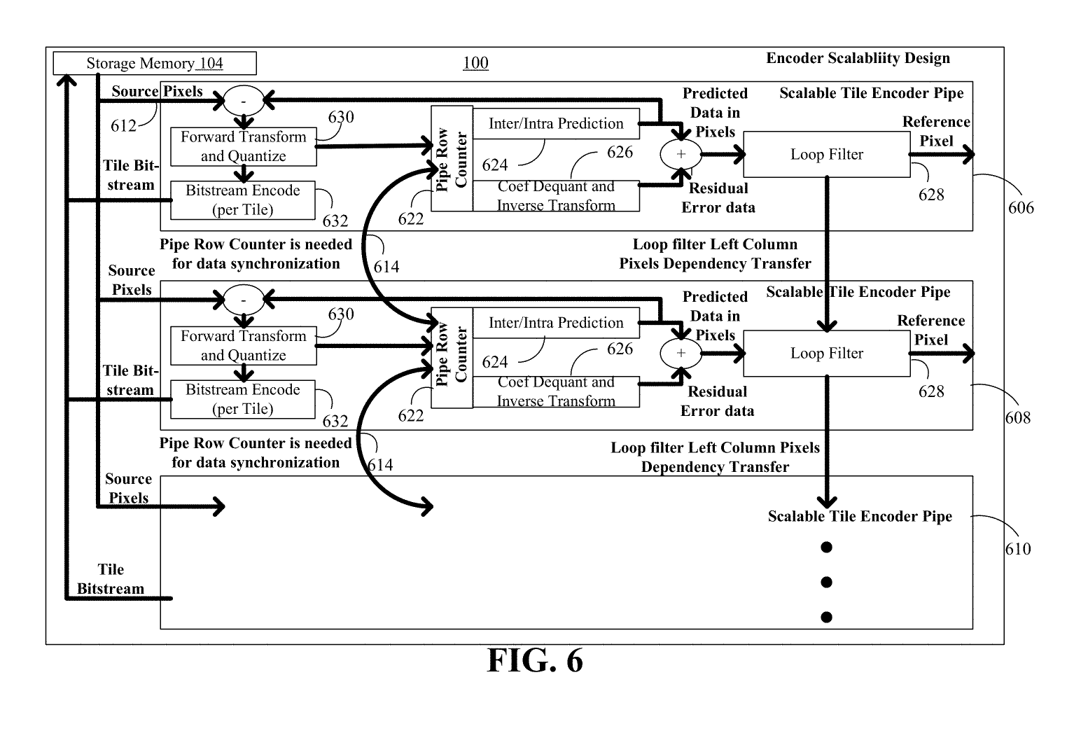

FIG. 6 is an illustrative block diagram of an example encoder implementation of scalable media architecture system 100 according to an embodiment.

In the illustrated example, scalable media architecture system 100 may be implemented as an encoder scalability design.

The scalable tile encoder pipes 606, 608, and 610 may process tiles in tile columns and multiple scalable tile encoder pipes 606, 608, and 610 can be linked together to process one frame. Each scalable tile encoder pipes 606, 608, and 610 may receive source pixels 612 from storage memory 604 for its corresponding tile columns.

The arrows between scalable tile encoder pipes 606, 608, and 610 indicate data dependency transfer between pipes. For example, pipe row counters 614 may be used to track which row in the neighboring scalable tile encoder pipes 606, 608, and 610 have been complete. These pipe row counters 614 may be used to synchronize the scalable tile encoder pipes 606, 608, and 610 and transfer the dependency data between pipes only when the neighboring pipes have finished the largest coding unit (LCU) with the dependency data.

The remaining arrows indicate the loop filter left column pixels dependency transfer 620.

In some examples, individual pipes of scalable tile encoder pipes 606, 608, and 610 may include a pipe row counter 622 performing the pipe row count for data synchronization. In the illustrated encoder scalability design, individual pipes of scalable tile encoder pipes 606, 608, and 610 may perform operations for inter/intra prediction at box 624, coefficient dequantization and inverse transform at box 626, and loop filtering at box 628 as part of an internal decoder loop. The source pixels may be combined with the output of the internal decoder loop and passed on to perform operations for forward transform and quantization at box 630 and bitstream encoding at box 632.

Additionally, scalable tile encoder pipe 610 indicates that the backend scalable tile encoder pipes can be scaled up as many times as needed and run in a concurrent manner to process a single picture. Each of the scalable tile encoder pipes 606, 608, and 610 may process one tile column (e.g., the width of the tile column must match the encoding tile width, which is specified by driver/application requirements). Each pipe will generate a bitstream per tile and it may typically require stitching to form the frame bitstream.

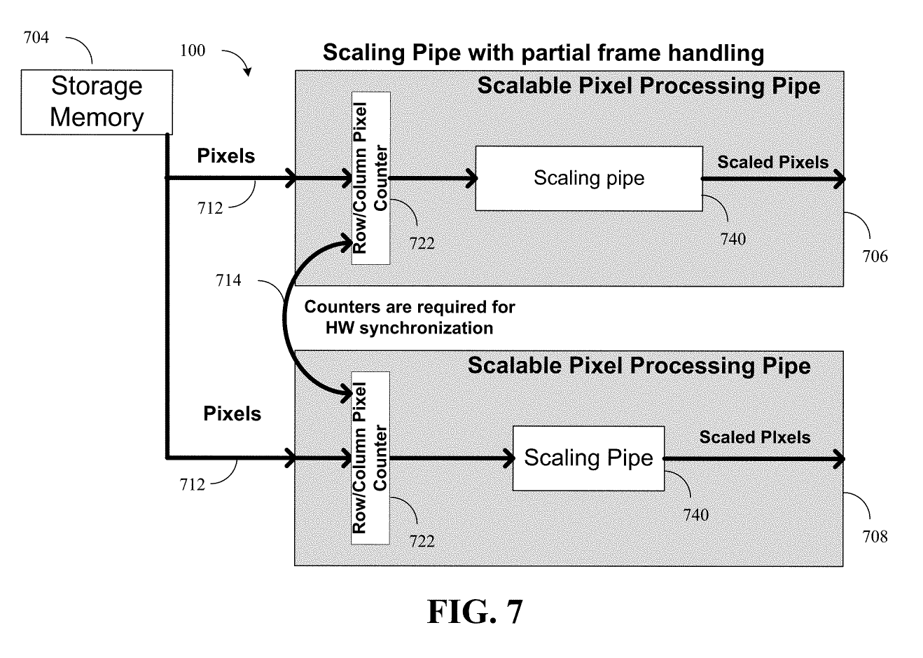

FIG. 7 is an illustrative block diagram of an example scaling video processing implementation of scalable media architecture system 100 according to an embodiment.

In the illustrated example, scalable media architecture system 100 may be implemented as a scaling pipe with each pipe having partial frame handling. In such an implementation, scalable media architecture system 100 may be used for video enhancement, scalar conversion, format conversion, the like, and/or combinations thereof.

The scalable pixel processing pipes 706 and 708 may process pixels in columns and multiple scalable pixel processing pipes 706 and 708 can be linked together to process one frame. Each scalable pixel processing pipes 706 and 708 may receive source pixels 712 from storage memory 704 for its corresponding columns.

The arrows between scalable pixel processing pipes 706 and 708 indicate data dependency transfer between pipes. For example, pipe row counters 714 may be used to track which row in the neighboring scalable pixel processing pipes 706 and 708 have been complete. These pipe row counters 714 may be used to synchronize the scalable pixel processing pipes 706 and 708 and transfer the dependency data between pipes only when the neighboring pipes have finished the largest coding unit (LCU) with the dependency data.

In some examples, individual pipes of scalable pixel processing pipes 706 and 708 may include a pipe row counter 622 performing the pipe row count for data synchronization. In the illustrated encoder scalability design, individual pipes of scalable pixel processing pipes 706 and 708 may perform operations to scalably process frames via scaling pipes at box 740.

Additionally, the backend scalable pixel processing pipes can be scaled up as many times as needed and run in a concurrent manner to process a single picture.

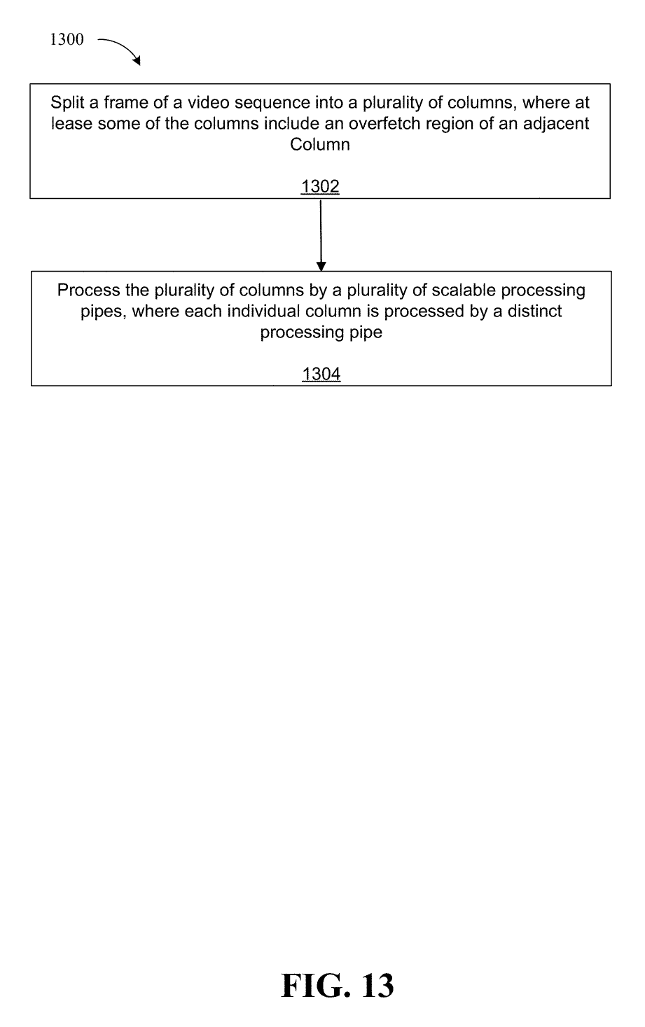

FIG. 13 is a flowchart of an example of a method 1300 of scalable media processing according to an embodiment. As illustrated, the method 1300 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 1300 may be written in any combination of one or more programming languages, including an object oriented programming language such as JAVA, SMALLTALK, C++or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 1302 provides for splitting a frame of the video sequence into a plurality of columns. For example, a frame of the video sequence may be split into a plurality of columns where at least some of the plurality of columns include an overfetch region of a second column of the plurality of columns that overlaps with an adjacent first column of the plurality of columns.

Illustrated processing block 1304 provides for processing the plurality of columns by a plurality of scalable pixel processing pipes. For example, the plurality of columns may be processed by a plurality of scalable pixel processing pipes, where each individual column of the plurality of columns is processed by a distinct one of the scalable pixel processing pipes.

In some examples, process 1300 may include operations to maintain tile boundaries of the frame during the splitting of the frame into the plurality of columns, where the frame is composed of a plurality of tiles.

In other examples, process 1300 may include operations to artificially split at least one tile into two virtual tiles along a column boundary during the splitting of the frame into the plurality of columns, where the frame is composed of a plurality of tiles.

In a further example, process 1300 may include operations to select, via an active application, between a first distribution mode and a second distribution mode based on video processing performance. In such an example, the first distribution mode includes maintaining tile boundaries of the frame during the splitting of the frame into the plurality of columns, where the frame is composed of a plurality of tiles. Further, the second distribution mode includes artificially splitting at least one tile into two virtual tiles along a column boundary during the splitting of the frame into the plurality of columns.

In a still further example, process 1300 may include operations to manage dependencies among the plurality of columns via hardware to hardware messaging.

In another example, process 1300 may include operations to perform loop filtering in a single pass across the entire frame via the plurality of scalable pixel processing pipes.

In still another example, process 1300 may include operations where the plurality of scalable pixel processing pipes are incorporated within an encoder pipe.

In yet another example, process 1300 may include operations where the plurality of scalable pixel processing pipes are incorporated within a decoder pipe.

In yet a further example, process 1300 may include operations where the plurality of scalable pixel processing pipes are incorporated within a scalar and format conversion pipe.

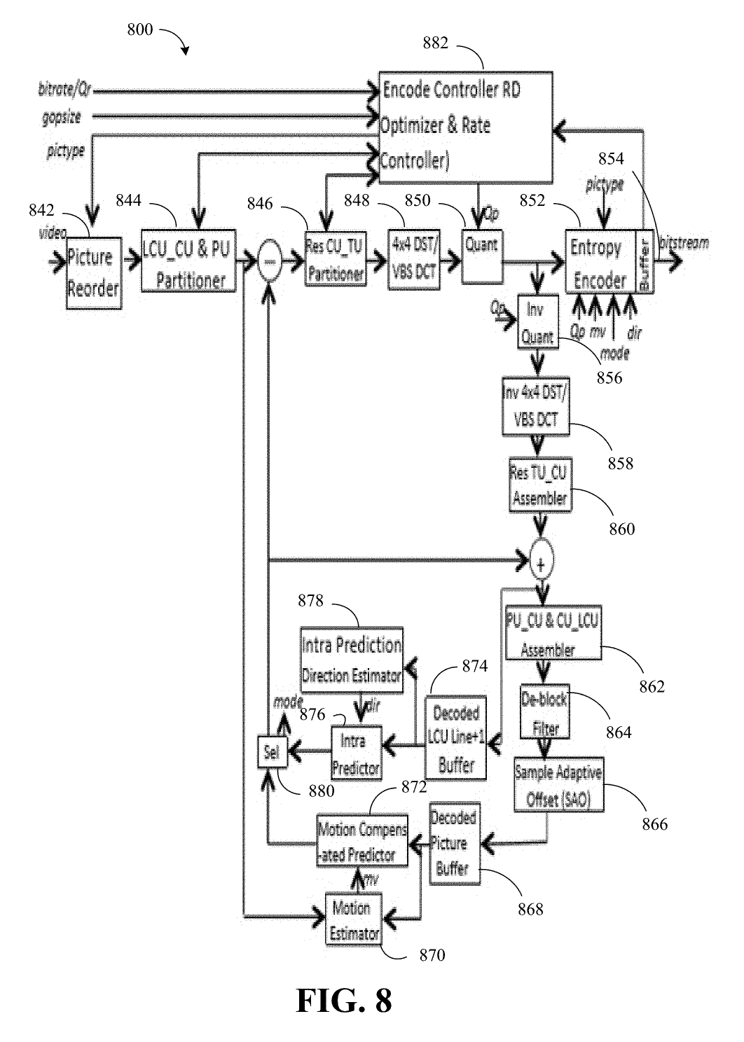

FIG. 8 is an illustrative diagram of an example High Efficiency Video Coder (HEVC) video encoder 800, arranged in accordance with at least some implementations of the present disclosure. In various implementations, video encoder 800 may be configured to undertake video coding and/or implement video codecs according to one or more advanced video codec standards, such as, for example, the Advanced Video Coding (e.g., AVC/H.264) video compression standard or the High Efficiency Video Coding (e.g., HEVC/H.265) video compression standard, but is not limited in this regard. Further, in various embodiments, video encoder 800 may be implemented as part of an image processor, video processor, and/or media processor.

As illustrated in FIG. 8, the high level operation of video encoder 800 follows the principles of general inter-frame encoders. For instance, video encoder 800 of FIG. 8 typically either uses a combination of either I- and P-pictures only or I-, P- and B-pictures (note that in HEVC a generalized B-picture (GBP) can be used in place of P-picture) in a non-pyramid, or pyramid GOP arrangement. Further like H.264/AVC coding, not only B-pictures (that can use bi-directional references), but also P-picture can also use multiple references (these references are unidirectional for P-pictures). As in previous standards B-pictures implies forward and backward references, and hence picture reordering is necessary.

In some examples, during the operation of video encoder 800, current video information may be provided to a picture reorder 842 in the form of a frame of video data. Picture reorder 842 may determine the picture type (e.g., I-, P-, or B-frame) of each video frame and reorder the video frames as needed.

The current video frame may be split from Largest Coding Units (LCUs) to coding units (CUs), and a coding unit (CU) may be recursively partitioned into smaller coding units (CUs); additionally, the coding units (CUs) may be partitioned for prediction into prediction units (PUs) at prediction partitioner 844 (e.g., “LC_CU & PU Partitioner). A coding partitioner 846 (e.g., “Res CU_TU Partitioner) may partition residual coding units (CUs) into transform units (TUs).

The coding partitioner 846 may be subjected to known video transform and quantization processes, first by a transform 848 (e.g., 4×4DCT/VBS DCT), which may perform a discrete cosine transform (DCT) operation, for example. Next, a quantizer 850 (e.g., Quant) may quantize the resultant transform coefficients.

The output of transform and quantization operations may be provided to an entropy encoder 852 as well as to an inverse quantizer 856 (e.g., Inv Quant) and inverse transform 858 (e.g., Inv 4×4DCT/VBS DCT). Entropy encoder 852 may output an entropy-encoded bitstream 854 for communication to a corresponding decoder.

Within the internal decoding loop of video encoder 800, inverse quantizer 856 and inverse transform 858 may implement the inverse of the operations undertaken by transform 848 and quantizer 850 to provide output to a residual assembler 860 (e.g., Res TU_CU Assembler).

The output of residual assembler 860 may be provided to a loop including a prediction assembler 862 (e.g., PU_CU & CU_LCU Assembler), a de-block filter 864, a sample adaptive offset filter 866 (e.g., Sample Adaptive Offset (SAO)), a decoded picture buffer 868, a motion estimator 870, a motion compensated predictor 872, a decoded largest coding unit line plus one buffer 874 (e.g., Decoded LCU Line+1 Buffer), an intra prediction direction estimator 876, and an intra predictor 878. As shown in FIG. 8, the output of either motion compensated predictor 872 or intra predictor 878 is selected via selector 880 (e.g., Sel) and may be combined with the output of residual assembler 860 as input to de-blocking filter 864, and is differenced with the output of prediction partitioner 844 to act as input to coding partitioner 846. An encode controller 882 (e.g., Encode Controller RD Optimizer & Rate Controller) may operate to perform Rate Distortion Optimization (RDO) operations and control the rate of video encoder 800.

In operation, the Largest Coding Unit (LCU) to coding units (CU) partitioner partitions LCU's to CUs, and a CU can be recursively partitioned into smaller CU's. The CU to prediction unit (PU) partitioner partitions CUs for prediction into PUs, and the TU partitioner partitions residual CUs into Transforms Units (TUs). TUs correspond to the size of transform blocks used in transform coding. The transform coefficients are quantized according to Qp in bitstream. Different Qp's can be specified for each CU depending on maxCuDQpDepth with LCU based adaptation being of the least granularity. The encode decisions, quantized transformed difference and motion vectors and modes are encoded in the bitstream using Context Adaptive Binary Arithmetic Coder (CABAC).

An Encode Controller 862 controls the degree of partitioning performed, which depends on quantizer used in transform coding. The CU/PU Assembler and TU Assembler perform the reverse function of partitioner. The decoded (e.g., every DPCM encoder incorporates a decoder loop) intra/motion compensated difference partitions are assembled following inverse DST/DCT to which prediction PUs are added and reconstructed signal then Deblock, and SAO Filtered that correspondingly reduce appearance of artifacts and restore edges impacted by coding. HEVC uses Intra and Inter prediction modes to predict portions of frames and encodes the difference signal by transforming it. HEVC uses various transform sizes called Transforms Units (TU). The transform coefficients are quantized according to Qp in the bitstream. Different Qps can be specified for each CU depending on maxCuDQpDepth.

As used herein, the term “coder” may refer to an encoder and/or a decoder. Similarly, as used herein, the term “coding” may refer to encoding via an encoder and/or decoding via a decoder. For example video encoder 800, and the like may include a video encoder with an internal video decoder, as illustrated in FIG. 8, while a companion coder may only include a video decoder (not illustrated independently here), and both are examples of a “coder” capable of coding.

Embodiments of the method of scalable media architecture system 100 (e.g., scalable media architecture system 100 of FIG. 1, FIG. 6 and/or FIG. 7) (and other methods herein) may be implemented in a system, apparatus, processor, reconfigurable device, etc., for example, such as those described herein. More particularly, hardware implementations of the method 2900 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method of scalable media architecture system 100 (e.g., scalable media architecture system 100 of FIG. 1, FIG. 6 and/or FIG. 7) may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, embodiments or portions of the method of scalable media architecture system 100 (e.g., scalable media architecture system 100 of FIG. 1, FIG. 6 and/or FIG. 7) (and other methods herein) may be implemented in applications (e.g., through an application programming interface/API) or driver software running on an OS. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

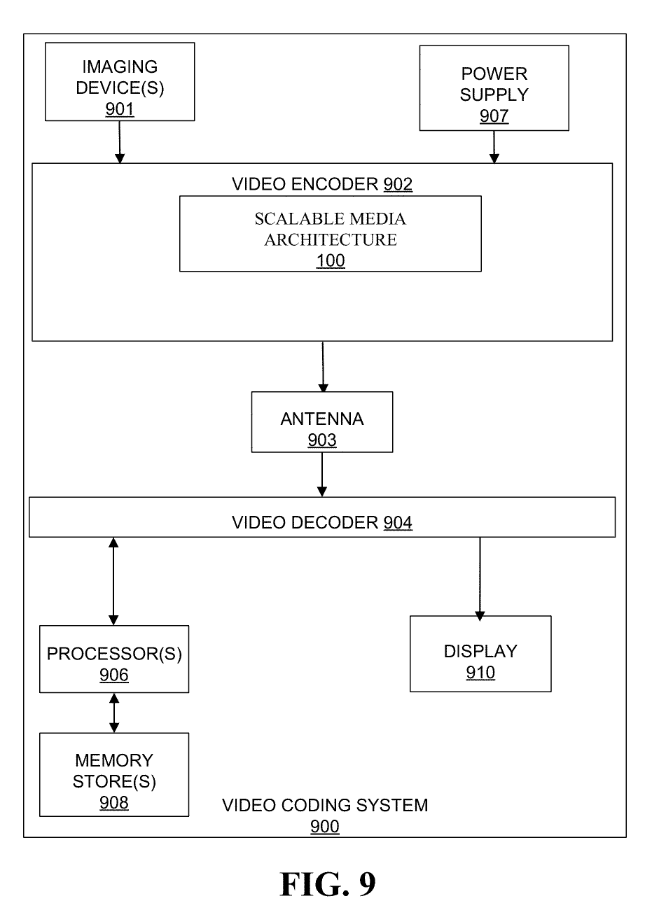

FIG. 9 is an illustrative diagram of example video coding system 900, arranged in accordance with at least some implementations of the present disclosure. In the illustrated implementation, video coding system 900, although illustrated with both video encoder 902 and video decoder 904, video coding system 900 may include only video encoder 902 or only video decoder 904 in various examples. Video coding system 900 may include imaging device(s) 901, an antenna 903, one or more processor(s) 906, one or more memory store(s) 908, a power supply 907, and/or a display device 910. As illustrated, imaging device(s) 901, antenna 903, video encoder 902, video decoder 904, processor(s) 906, memory store(s) 908, and/or display device 910 may be capable of communication with one another.

In some examples, video coding system 900 may include a scalable media architecture system 100 (e.g., scalable media architecture system 100 of FIG. 1, FIG. 6 and/or FIG. 7) associated with video encoder 902 and/or video decoder 904. Further, antenna 903 may be configured to transmit or receive an encoded bitstream of video data, for example. Processor(s) 906 may be any type of processor and/or processing unit. For example, processor(s) 906 may include distinct central processing units, distinct graphic processing units, integrated system-on-a-chip (SoC) architectures, the like, and/or combinations thereof. In addition, memory store(s) 908 may be any type of memory. For example, memory store(s) 908 may be volatile memory (e.g., Static Random Access Memory (SRAM), Dynamic Random Access Memory (DRAM), etc.) or non-volatile memory (e.g., flash memory, etc.), and so forth. In a non-limiting example, memory store(s) 908 may be implemented by cache memory. Further, in some implementations, video coding system 900 may include display device 910. Display device 910 may be configured to present video data.

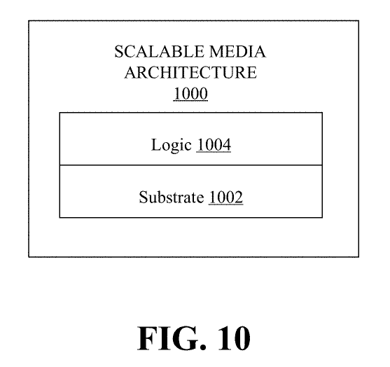

FIG. 10 shows a scalable media architecture 1000 (e.g., semiconductor package, chip, die). The apparatus 1000 may implement one or more aspects of scalable media architecture system 100 (e.g., scalable media architecture system 100 of FIG. 1, FIG. 6 and/or FIG. 7). The apparatus 1000 may be readily substituted for some or all of the scalable media architecture system 100 (e.g., scalable media architecture system 100 of FIG. 1, FIG. 6 and/or FIG. 7), already discussed.

The illustrated apparatus 1000 includes one or more substrates 1002 (e.g., silicon, sapphire, gallium arsenide) and logic 1004 (e.g., transistor array and other integrated circuit/IC components) coupled to the substrate(s) 1002. The logic 1004 may be implemented at least partly in configurable logic or fixed-functionality logic hardware. In one example, the logic 1004 includes transistor channel regions that are positioned (e.g., embedded) within the substrate(s) 1002. Thus, the interface between the logic 1004 and the substrate(s) 1002 may not be an abrupt junction. The logic 1004 may also be considered to include an epitaxial layer that is grown on an initial wafer of the substrate(s) 1002.

Moreover, the logic 1004 may configure one or more first logical cores associated with a first virtual machine of a cloud server platform, where the configuration of the one or more first logical cores is based at least in part on one or more first feature settings. The logic 1004 may also configure one or more active logical cores associated with an active virtual machine of the cloud server platform, where the configuration of the one or more active logical cores is based at least in part on one or more active feature settings, and where the active feature settings are different than the first feature settings.

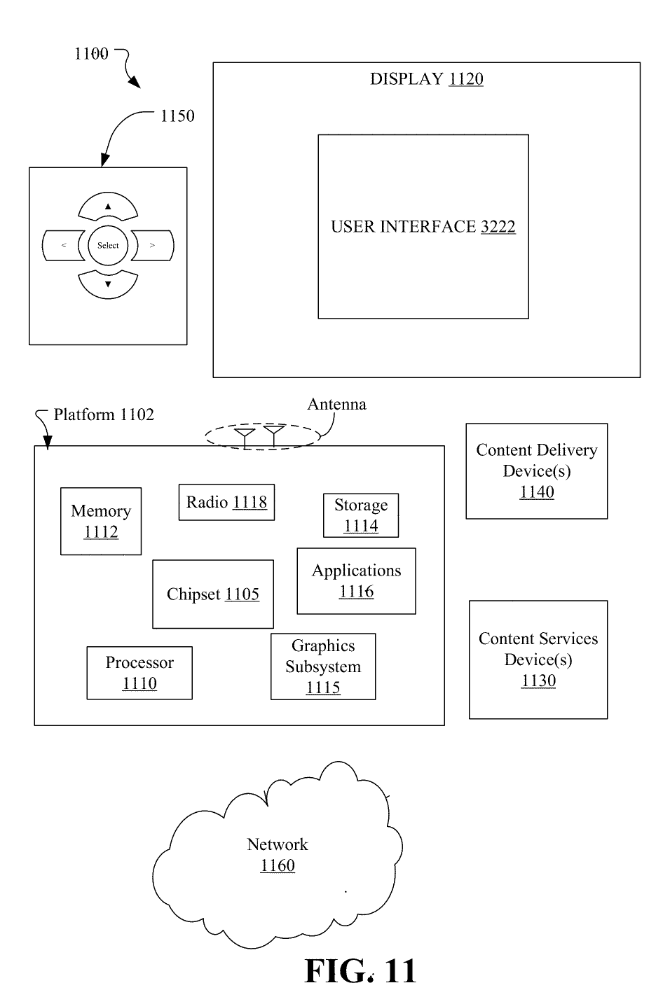

FIG. 11 illustrates an embodiment of a system 1100. In embodiments, system 1100 may include a media system although system 1100 is not limited to this context. For example, system 1100 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, the system 1100 comprises a platform 1102 coupled to a display 1120 that presents visual content. The platform 1102 may receive video bitstream content from a content device such as content services device(s) 1130 or content delivery device(s) 1140 or other similar content sources. A navigation controller 1150 comprising one or more navigation features may be used to interact with, for example, platform 1102 and/or display 1120. Each of these components is described in more detail below.

In embodiments, the platform 1102 may comprise any combination of a chipset 1105, processor 1110, memory 1112, storage 1114, graphics subsystem 1115, applications 1116 and/or radio 1118 (e.g., network controller). The chipset 1105 may provide intercommunication among the processor 1110, memory 1112, storage 1114, graphics subsystem 1115, applications 1116 and/or radio 1118. For example, the chipset 1105 may include a storage adapter (not depicted) capable of providing intercommunication with the storage 1114.

The processor 1110 may be implemented as Complex Instruction Set Computer (CISC) or Reduced Instruction Set Computer (RISC) processors, x86 instruction set compatible processors, multi-core, or any other microprocessor or central processing unit (CPU). In embodiments, the processor 1110 may comprise dual-core processor(s), dual-core mobile processor(s), and so forth.

The memory 1112 may be implemented as a volatile memory device such as, but not limited to, a Random Access Memory (RAM), Dynamic Random Access Memory (DRAM), or Static RAM (SRAM).

The storage 1114 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 1114 may comprise technology to increase the storage performance enhanced protection for valuable digital media when multiple hard drives are included, for example.

The graphics subsystem 1115 may perform processing of images such as still or video for display. The graphics subsystem 1115 may be a graphics processing unit (GPU) or a visual processing unit (VPU), for example. An analog or digital interface may be used to communicatively couple the graphics subsystem 1115 and display 1120. For example, the interface may be any of a High-Definition Multimedia Interface (HDMI), DisplayPort, wireless HDMI, and/or wireless HD compliant techniques. The graphics subsystem 1115 could be integrated into processor 1110 or chipset 1105. The graphics subsystem 1115 could be a stand-alone card communicatively coupled to the chipset 1105. In one example, the graphics subsystem 1115 includes a noise reduction subsystem as described herein.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 1118 may be a network controller including one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 1118 may operate in accordance with one or more applicable standards in any version.

In embodiments, the display 1120 may comprise any television type monitor or display. The display 1120 may comprise, for example, a computer display screen, touch screen display, video monitor, television-like device, and/or a television. The display 1120 may be digital and/or analog. In embodiments, the display 1120 may be a holographic display. Also, the display 1120 may be a transparent surface that may receive a visual projection. Such projections may convey various forms of information, images, and/or objects. For example, such projections may be a visual overlay for a mobile augmented reality (MAR) application. Under the control of one or more software applications 1116, the platform 1102 may display user interface 1122 on the display 1120.

In embodiments, content services device(s) 1130 may be hosted by any national, international and/or independent service and thus accessible to the platform 1102 via the Internet, for example. The content services device(s) 1130 may be coupled to the platform 1102 and/or to the display 1120. The platform 1102 and/or content services device(s) 1130 may be coupled to a network 1160 to communicate (e.g., send and/or receive) media information to and from network 1160. The content delivery device(s) 1140 also may be coupled to the platform 1102 and/or to the display 1120.

In embodiments, the content services device(s) 1130 may comprise a cable television box, personal computer, network, telephone, Internet enabled devices or appliance capable of delivering digital information and/or content, and any other similar device capable of unidirectionally or bidirectionally communicating content between content providers and platform 1102 and/display 1120, via network 1160 or directly. It will be appreciated that the content may be communicated unidirectionally and/or bidirectionally to and from any one of the components in system 1100 and a content provider via network 1160. Examples of content may include any media information including, for example, video, music, medical and gaming information, and so forth.

The content services device(s) 1130 receives content such as cable television programming including media information, digital information, and/or other content. Examples of content providers may include any cable or satellite television or radio or Internet content providers. The provided examples are not meant to limit embodiments.

In embodiments, the platform 1102 may receive control signals from a navigation controller 1150 having one or more navigation features. The navigation features of the controller 1150 may be used to interact with the user interface 1122, for example. In embodiments, the navigation controller 1150 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of the controller 1150 may be echoed on a display (e.g., display 1120) by movements of a pointer, cursor, focus ring, or other visual indicators displayed on the display. For example, under the control of software applications 1116, the navigation features located on the navigation controller 1150 may be mapped to virtual navigation features displayed on the user interface 1122, for example. In embodiments, the controller 1150 may not be a separate component but integrated into the platform 1102 and/or the display 1120. Embodiments, however, are not limited to the elements or in the context shown or described herein.

In embodiments, drivers (not shown) may comprise technology to enable users to instantly turn on and off the platform 1102 like a television with the touch of a button after initial boot-up, when enabled, for example. Program logic may allow the platform 1102 to stream content to media adaptors or other content services device(s) 1130 or content delivery device(s) 1140 when the platform is turned “off.” In addition, chipset 1105 may comprise hardware and/or software support for (5.1) surround sound audio and/or high definition (7.1) surround sound audio, for example. Drivers may include a graphics driver for integrated graphics platforms. In embodiments, the graphics driver may comprise a peripheral component interconnect (PCI) Express graphics card.

In various embodiments, any one or more of the components shown in the system 1100 may be integrated. For example, the platform 1102 and the content services device(s) 1130 may be integrated, or the platform 1102 and the content delivery device(s) 1140 may be integrated, or the platform 1102, the content services device(s) 1130, and the content delivery device(s) 1140 may be integrated, for example. In various embodiments, the platform 1102 and the display 1120 may be an integrated unit. The display 1120 and content service device(s) 1130 may be integrated, or the display 1120 and the content delivery device(s) 1140 may be integrated, for example. These examples are not meant to limit the embodiments.

In various embodiments, system 1100 may be implemented as a wireless system, a wired system, or a combination of both. When implemented as a wireless system, system 1100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

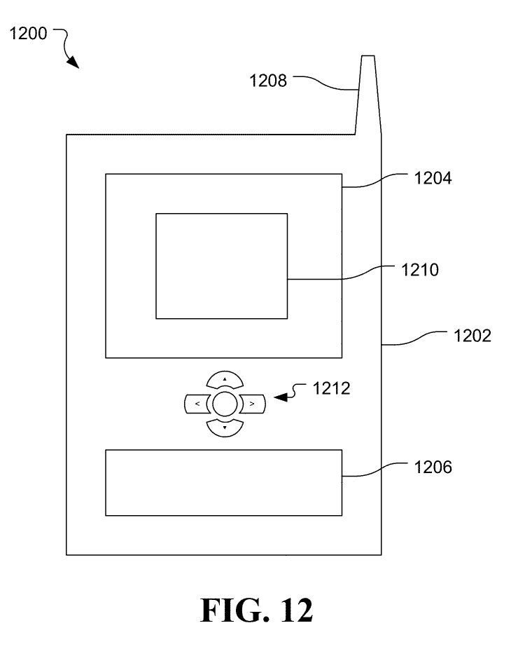

The platform 1102 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system or instruct a node to process the media information in a predetermined manner. The embodiments, however, are not limited to the elements or in the context shown or described in FIG. 12.

As described above, the system 1100 may be embodied in varying physical styles or form factors. FIG. 12 illustrates embodiments of a small form factor device 1200 in which the system 1100 may be embodied. In embodiments, for example, the device 1200 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 12, the device 1200 may comprise a housing 1202, a display 1204, an input/output (I/O) device 1206, and an antenna 1208. The device 1200 also may comprise navigation features 1212. The display 1204 may comprise any suitable display unit for displaying information appropriate for a mobile computing device. The I/O device 1206 may comprise any suitable I/O device for entering information into a mobile computing device. Examples for the I/O device 1206 may include an alphanumeric keyboard, a numeric keypad, a touch pad, input keys, buttons, switches, rocker switches, microphones, speakers, voice recognition device and software, and so forth. Information also may be entered into the device 1200 by way of microphone. Such information may be digitized by a voice recognition device. The embodiments are not limited in this context.

### Additional Notes and Examples

Example 1 includes a computing system for scalable processing of a video sequence, the computing system including: one or more processors, and a memory coupled to the one or more processors.

The memory includes executable program instructions, which when executed by the host processor, cause the computing system to: split a frame of the video sequence into a plurality of columns, where at least some of the plurality of columns include an overfetch region of a second column of the plurality of columns that overlaps with an adjacent first column of the plurality of columns, and process the plurality of columns by a plurality of scalable pixel processing pipes, where each individual column of the plurality of columns is processed by a distinct one of the scalable pixel processing pipes.

Example 2 includes the computing system of Example 1, where the executable program instructions, when executed by the computing system, cause the computing system to: maintain tile boundaries of the frame during the splitting of the frame into the plurality of columns, where the frame is composed of a plurality of tiles.

Example 3 includes the computing system of Example 1, where the executable program instructions, when executed by the computing system, cause the computing system to: artificially split at least one tile into two virtual tiles along a column boundary during the splitting of the frame into the plurality of columns, where the frame is composed of a plurality of tiles.

Example 4 includes the computing system of Example 1, where the executable program instructions, when executed by the computing system, cause the computing system to: select, via an active application, between a first distribution mode and a second distribution mode based on video processing performance; where the first distribution mode includes maintaining tile boundaries of the frame during the splitting of the frame into the plurality of columns, where the frame is composed of a plurality of tiles; and where the second distribution mode includes artificially splitting at least one tile into two virtual tiles along a column boundary during the splitting of the frame into the plurality of columns.

Example 5 includes the computing system of Example 1, where the executable program instructions, when executed by the computing system, cause the computing system to: manage dependencies among the plurality of columns via hardware to hardware messaging.

Example 6 includes the computing system of Example 1, where the executable program instructions, when executed by the computing system, cause the computing system to: perform loop filtering in a single pass across the entire frame via the plurality of scalable pixel processing pipes.

Example 7 includes the computing system of Example 1, where the plurality of scalable pixel processing pipes are incorporated within an encoder pipe.

Example 8 includes the computing system of Example 1, where the plurality of scalable pixel processing pipes are incorporated within a decoder pipe.

Example 9 includes the computing system of Example 1, where the plurality of scalable pixel processing pipes are incorporated within a scalar and format conversion pipe.

Example 10 includes a semiconductor apparatus for scalable processing of a video sequence, the semiconductor apparatus including: one or more substrates; and logic coupled to the one or more substrates, where the logic is implemented at least partly in one or more of configurable logic or fixed-functionality hardware logic, the logic coupled to the one or more substrates to: split a frame of the video sequence into a plurality of columns, where at least some of the plurality of columns include an overfetch region of a second column of the plurality of columns that overlaps with an adjacent first column of the plurality of columns; and process the plurality of columns by a plurality of scalable pixel processing pipes, where each individual column of the plurality of columns is processed by a distinct one of the scalable pixel processing pipes.

Example 11 includes the semiconductor apparatus of claim 10, where the logic coupled to the one or more substrates is to: maintain tile boundaries of the frame during the splitting of the frame into the plurality of columns, where the frame is composed of a plurality of tiles.

Example 12 includes the semiconductor apparatus of claim 10, where the logic coupled to the one or more substrates is to: artificially split at least one tile into two virtual tiles along a column boundary during the splitting of the frame into the plurality of columns, where the frame is composed of a plurality of tiles.

Example 13 includes the semiconductor apparatus of claim 10, where the logic coupled to the one or more substrates is to: select, via an active application, between a first distribution mode and a second distribution mode based on video processing performance; where the first distribution mode includes maintaining tile boundaries of the frame during the splitting of the frame into the plurality of columns, where the frame is composed of a plurality of tiles; and where the second distribution mode includes artificially splitting at least one tile into two virtual tiles along a column boundary during the splitting of the frame into the plurality of columns.

Example 14 includes the semiconductor apparatus of claim 10, where the logic coupled to the one or more substrates is to: manage dependencies among the plurality of columns via hardware to hardware messaging.

Example 15 includes the semiconductor apparatus of claim 10, where the logic coupled to the one or more substrates is to: perform loop filtering in a single pass across the entire frame via the plurality of scalable pixel processing pipes.

Example 16 includes the semiconductor apparatus of claim 10, where the logic coupled to the one or more substrates includes transistor channel regions that are positioned within the one or more substrates.

Example 17 includes at least one computer readable storage medium including a set of executable program instructions, which when executed by a computing system, cause the computing system to: split a frame of the video sequence into a plurality of columns, where at least some of the plurality of columns include an overfetch region of a second column of the plurality of columns that overlaps with an adjacent first column of the plurality of columns; and process the plurality of columns by a plurality of scalable pixel processing pipes, where each individual column of the plurality of columns is processed by a distinct one of the scalable pixel processing pipes.

Example 18 includes the at least one computer readable storage medium of Example 17, where the executable program instructions, when executed by the computing system, cause the computing system to: maintain tile boundaries of the frame during the splitting of the frame into the plurality of columns, where the frame is composed of a plurality of tiles.

Example 19 includes the at least one computer readable storage medium of Example 17, where the executable program instructions, when executed by the computing system, cause the computing system to: artificially split at least one tile into two virtual tiles along a column boundary during the splitting of the frame into the plurality of columns, where the frame is composed of a plurality of tiles.

Example 20 includes the at least one computer readable storage medium of Example 17, where the executable program instructions, when executed by the computing system, cause the computing system to: select, via an active application, between a first distribution mode and a second distribution mode based on video processing performance; where the first distribution mode includes maintaining tile boundaries of the frame during the splitting of the frame into the plurality of columns, where the frame is composed of a plurality of tiles; and where the second distribution mode includes artificially splitting at least one tile into two virtual tiles along a column boundary during the splitting of the frame into the plurality of columns.

Example 21 includes scalable media method for a video sequence, including: splitting a frame of the video sequence into a plurality of columns, where at least some of the plurality of columns include an overfetch region of a second column of the plurality of columns that overlaps with an adjacent first column of the plurality of columns; and processing the plurality of columns by a plurality of scalable pixel processing pipes, where each individual column of the plurality of columns is processed by a distinct one of the scalable pixel processing pipes.

Example 22 includes the scalable media method of Example 21, further including maintaining tile boundaries of the frame during the splitting of the frame into the plurality of columns, where the frame is composed of a plurality of tiles.

Example 23 includes the scalable media method of Example 21, further including artificially splitting at least one tile into two virtual tiles along a column boundary during the splitting of the frame into the plurality of columns, where the frame is composed of a plurality of tiles.

Example 24 includes the scalable media method of Example 21, further including: selecting, via an active application, between a first distribution mode and a second distribution mode based on video processing performance; where the first distribution mode includes maintaining tile boundaries of the frame during the splitting of the frame into the plurality of columns, where the frame is composed of a plurality of tiles; and where the second distribution mode includes artificially splitting at least one tile into two virtual tiles along a column boundary during the splitting of the frame into the plurality of columns.

Example 25 includes the scalable media method of Example 21, further including managing dependencies among the plurality of columns via hardware to hardware messaging.

Example 26 includes the scalable media method of Example 21, further including performing loop filtering in a single pass across the entire frame via the plurality of scalable pixel processing pipes.

Example 27 includes means for performing a method as described in any preceding Example.

Example 28 includes machine-readable storage including machine-readable instructions which, when executed, implement a method or realize an apparatus as described in any preceding Example.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually include one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments of this have been described in connection with particular examples thereof, the true scope of the embodiments should not be so limited since other modifications will become apparent to the skilled practitioner upon a study of the drawings, specification, and following claims.

We claim:

1. A computing system for scalable processing of a video sequence, the computing system comprising:
one or more processors; and
a memory coupled to the one or more processors, the memory including executable program instructions, which when executed by the host processor, cause the computing system to:
split a frame of the video sequence into a plurality of columns, wherein at least some of the plurality of columns include an overfetch region of a second column of the plurality of columns that overlaps with an adjacent first column of the plurality of columns; and
process the plurality of columns by a plurality of scalable pixel processing pipes, wherein each individual column of the plurality of columns is processed by a distinct one of the scalable pixel processing pipes.

2. The computing system of claim 1, wherein the executable program instructions, when executed by the computing system, cause the computing system to:
maintain tile boundaries of the frame during the splitting of the frame into the plurality of columns, wherein the frame is composed of a plurality of tiles.

3. The computing system of claim 1, wherein the executable program instructions, when executed by the computing system, cause the computing system to:
artificially split at least one tile into two virtual tiles along a column boundary during the splitting of the frame into the plurality of columns, wherein the frame is composed of a plurality of tiles.

4. The computing system of claim 1, wherein the executable program instructions, when executed by the computing system, cause the computing system to:
select, via an active application, between a first distribution mode and a second distribution mode based on video processing performance;
wherein the first distribution mode includes maintaining tile boundaries of the frame during the splitting of the frame into the plurality of columns, wherein the frame is composed of a plurality of tiles; and
wherein the second distribution mode includes artificially splitting at least one tile into two virtual tiles along a column boundary during the splitting of the frame into the plurality of columns.

5. The computing system of claim 1, wherein the executable program instructions, when executed by the computing system, cause the computing system to:
manage dependencies among the plurality of columns via hardware to hardware messaging.

6. The computing system of claim 1, wherein the executable program instructions, when executed by the computing system, cause the computing system to:
perform loop filtering in a single pass across the entire frame via the plurality of scalable pixel processing pipes.

7. The computing system of claim 1, wherein the plurality of scalable pixel processing pipes are incorporated within an encoder pipe.

8. The computing system of claim 1, wherein the plurality of scalable pixel processing pipes are incorporated within a decoder pipe.

9. The computing system of claim 1, wherein the plurality of scalable pixel processing pipes are incorporated within a scalar and format conversion pipe.

10. A semiconductor apparatus for scalable processing of a video sequence, the semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
split a frame of the video sequence into a plurality of columns, wherein at least some of the plurality of columns include an overfetch region of a second column of the plurality of columns that overlaps with an adjacent first column of the plurality of columns; and
process the plurality of columns by a plurality of scalable pixel processing pipes, wherein each individual column of the plurality of columns is processed by a distinct one of the scalable pixel processing pipes.

11. The semiconductor apparatus of claim 10, wherein the logic coupled to the one or more substrates is to:
maintain tile boundaries of the frame during the splitting of the frame into the plurality of columns, wherein the frame is composed of a plurality of tiles.

12. The semiconductor apparatus of claim 10, wherein the logic coupled to the one or more substrates is to:
artificially split at least one tile into two virtual tiles along a column boundary during the splitting of the frame into the plurality of columns, wherein the frame is composed of a plurality of tiles.

13. The semiconductor apparatus of claim 10, wherein the logic coupled to the one or more substrates is to:
select, via an active application, between a first distribution mode and a second distribution mode based on video processing performance;
wherein the first distribution mode includes maintaining tile boundaries of the frame during the splitting of the frame into the plurality of columns, wherein the frame is composed of a plurality of tiles; and
wherein the second distribution mode includes artificially splitting at least one tile into two virtual tiles along a column boundary during the splitting of the frame into the plurality of columns.

14. The semiconductor apparatus of claim 10, wherein the logic coupled to the one or more substrates is to:
manage dependencies among the plurality of columns via hardware to hardware messaging.

15. The semiconductor apparatus of claim 10, wherein the logic coupled to the one or more substrates is to:
perform loop filtering in a single pass across the entire frame via the plurality of scalable pixel processing pipes.

16. The semiconductor apparatus of claim 10, wherein the logic coupled to the one or more substrates includes transistor channel regions that are positioned within the one or more substrates.

17. At least one computer readable storage medium comprising a set of executable program instructions, which when executed by a computing system, cause the computing system to:
split a frame of the video sequence into a plurality of columns, wherein at least some of the plurality of columns include an overfetch region of a second column of the plurality of columns that overlaps with an adjacent first column of the plurality of columns; and
process the plurality of columns by a plurality of scalable pixel processing pipes, wherein each individual column of the plurality of columns is processed by a distinct one of the scalable pixel processing pipes.

18. The at least one computer readable storage medium of claim 17, wherein the executable program instructions, when executed by the computing system, cause the computing system to:
maintain tile boundaries of the frame during the splitting of the frame into the plurality of columns, wherein the frame is composed of a plurality of tiles.

19. The at least one computer readable storage medium of claim 17, wherein the executable program instructions, when executed by the computing system, cause the computing system to:
artificially split at least one tile into two virtual tiles along a column boundary during the splitting of the frame into the plurality of columns, wherein the frame is composed of a plurality of tiles.

20. The at least one computer readable storage medium of claim 17, wherein the executable program instructions, when executed by the computing system, cause the computing system to:
select, via an active application, between a first distribution mode and a second distribution mode based on video processing performance;
wherein the first distribution mode includes maintaining tile boundaries of the frame during the splitting of the frame into the plurality of columns, wherein the frame is composed of a plurality of tiles; and
wherein the second distribution mode includes artificially splitting at least one tile into two virtual tiles along a column boundary during the splitting of the frame into the plurality of columns.

21. A scalable media method for a video sequence, comprising:
splitting a frame of the video sequence into a plurality of columns, wherein at least some of the plurality of columns include an overfetch region of a second column of the plurality of columns that overlaps with an adjacent first column of the plurality of columns; and
processing the plurality of columns by a plurality of scalable pixel processing pipes, wherein each individual column of the plurality of columns is processed by a distinct one of the scalable pixel processing pipes.

22. The scalable media method of claim 21, further comprising maintaining tile boundaries of the frame during the splitting of the frame into the plurality of columns, wherein the frame is composed of a plurality of tiles.

23. The scalable media method of claim 21, further comprising artificially splitting at least one tile into two virtual tiles along a column boundary during the splitting of the frame into the plurality of columns, wherein the frame is composed of a plurality of tiles.

24. The scalable media method of claim 21, further comprising:
selecting, via an active application, between a first distribution mode and a second distribution mode based on video processing performance;
wherein the first distribution mode includes maintaining tile boundaries of the frame during the splitting of the frame into the plurality of columns, wherein the frame is composed of a plurality of tiles; and
wherein the second distribution mode includes artificially splitting at least one tile into two virtual tiles along a column boundary during the splitting of the frame into the plurality of columns.

25. The scalable media method of claim 21, further comprising managing dependencies among the plurality of columns via hardware to hardware messaging.

26. The scalable media method of claim 21, further comprising performing loop filtering in a single pass across the entire frame via the plurality of scalable pixel processing pipes.
